(19) United States
(12) Patent Application Publication
(10) Pub. No.: US 2010/0221519 A1
(43) Pub. Date: Sep. 2, 2010

(54) PROCESS FOR PRODUCING NANO- AND MESOFIBERS BY ELECTROSPINNING COLLOIDAL DISPERSIONS COMPRISING AT LEAST ONE ESSENTIALLY WATER-INSOLUBLE POLYMER

(75) Inventors: Rajan Venkatesh, Singapore (SG); Evgueni Klimov, Ludwigshafen (DE); Michel Pepers, Ludwigshafen (DE); Walter Heckmann, Weinheim (DE); Jürgen Schmidt-Thümmes, Neuhofen (DE); Vijay Immanuel Raman, Mannheim (DE); Andreas Greiner, Amoneburg (DE); Aleksandar Stoiljkovic, Tarragona (ES)

Correspondence Address: CONNOLLY BOVE LODGE & HUTZ LLP, 1875 EYE STREET, N.W., SUITE 1100, WASHINGTON, DC, 20006, US

(73) Assignee: BASF SE, Ludwigshafen 38 (DE)

(21) Appl. No.: 12/669,690

(22) PCT Filed: Jul. 10, 2008
(86) PCT No.: PCT/EP2008/058983

§ 371 Date: May 10, 2010

(30) Foreign Application Priority Data
Jul. 18, 2007 (EP) 07112671.8

(51) Int. Cl. D01D 5/00; D04H 1/00; C08F 20/10

(52) U.S. Cl. 428/221; 264/465; 428/401; 526/319

(57) ABSTRACT

The present invention relates to a process for producing polymer fibers, especially nano- and mesofibers, by electrospinning a colloidal dispersion of at least one essentially water-insoluble polymer in an aqueous medium, and to fibers obtainable by this process, to textile fabrics comprising the inventive fibers, and to the use of the inventive fibers and of the inventive textile fabrics.

The present invention relates to a process for producing polymer fibers, especially nano- and mesofibers, by electrospinning a colloidal dispersion of at least one essentially water-insoluble polymer in an aqueous medium, and to fibers obtainable by this process, to textile fabrics comprising the inventive fibers, and to the use of the inventive fibers and of the inventive textile fabrics.

For the production of nano- and mesofibers, a multitude of processes are known to those skilled in the art, among which electrospinning is currently of the greatest significance. In this process, which is described, for example, by D. H. Reneker, H. D. Chun in Nanotech. 7 (1996), page 216 ff., a polymer melt or a polymer solution is typically exposed to a high electrical field at an edge which serves as an electrode. This can be achieved, for example, by extrusion of the polymer melt or polymer solution in an electrical field under low pressure by a cannula connected to one pole of a voltage source. Owing to the resulting electrostatic charge of the polymer melt or polymer solution, there is a material flow directed toward the counterelectrode, which solidifies on the way to the counterelectrode. Depending on the electrode geometries, nonwovens or assemblies of ordered fibers are obtained by this process.

DE-A1-101 33 393 discloses a process for producing hollow fibers with an internal diameter of from 1 to 100 nm, in which a solution of a water-insoluble polymer—for example a poly-L-lactide solution in dichloromethane or a polyamide-46 solution in pyridine—is electrospun. A similar process is also known from WO-A1-01/09414 and DE-A1-103 55 665.

DE-A1-196 00 162 discloses a process for producing lawnmower wire or textile fabrics, in which polyamide, polyester or polypropylene as a thread-forming polymer, a maleic anhydride-modified polyethylene/polypropylene rubber and one or more aging stabilizers are combined, melted and mixed with one another, before this melt is melt-spun.

DE-A1-10 2004 009 887 relates to a process for producing fibers having a diameter of <50 μm by electrostatic spinning or spraying of a melt of at least one thermoplastic polymer.

The electrospinning of polymer melts allows only fibers of diameters greater than 1 μm to be produced. For a multitude of applications, for example filtration applications, however, nano- and/or mesofibers having a diameter of less than 1 μm are required, which can be produced with the known electrospinning processes only by use of polymer solutions.

However, these processes have the disadvantage that the polymers to be spun first have to be brought into solution. For water-insoluble polymers, such as polyamides, polyolefins, polyesters or polyurethanes, nonaqueous solvents—regularly organic solvents—therefore have to be used, which are generally toxic, combustible, irritant, explosive and/or corrosive.

In the case of water-insoluble polymers, such as polyvinyl alcohol, polyethylene oxide, polyvinylpyrrolidone or hydroxypropylcellulose, it is possible to dispense with the use of nonaqueous solvents. However, fibers obtained in this way are by their nature water-soluble, which is why their industrial use is very limited. For this reason, these fibers have to be stabilized toward water after the electrospinning by at least one further processing step, for example by chemical crosslinking, which constitutes considerable technical complexity and increases the production costs of the fibers.

WO 2004/080681 A1 relates to apparatus and processes for the electrostatic processing of polymer formulations. The polymer formulations may be solutions, dispersions, suspensions, emulsions, mixtures thereof or polymer melts. One process mentioned for electrostatic processing is electrospinning. However, WO 2004/080681 A1 does not mention any specific polymer formulations which are suitable for electrospinning.

WO 2004/048644 A2 discloses the electrosynthesis of nanofibers and nanocomposite films. For the electrospinning, solutions of suitable starting substances are used. According to the description, the term “solvents” also comprises heterogeneous mixtures such as suspensions or dispersions. According to WO 2004/048644 A2, fibers can be produced, inter alia, from electrically conductive polymers. According to WO 2004/048644 A2, these are obtained preferably from the solutions comprising the corresponding monomers.

WO 2006/089522A1 relates to a process for producing polymer fibers by electrospinning a colloidal dispersion of at least one essentially water-insoluble polymer in an aqueous medium. In this process, it was possible for the first time to spin aqueous polymer dispersions by means of an electrospinning process to obtain polymer fibers, especially nano- or mesofibers. According to the examples of WO 2006/089522A1, a latex is electrospun from a partly crosslinked poly(n-butyl acrylate) having a glass transition temperature of −43° C. (according to Polymer Handbook (4th edition), edited by: Brandrup, J.; Immergut, Edmund H.; Grulke, Eric A.; Abe, Akihiro; Bloch, Daniel R. © 1999; 2005 John Wiley & Sons) at a temperature of 20° C.

With the aid of the process described in WO 2006/089522A1, it has been possible to avoid the aforementioned disadvantages of the prior art and to provide a process for producing water-stable polymer fibers, especially nano- and mesofibers, by the electrospinning process, in which the use of nonaqueous solvents to prepare a polymer solution and an aftertreatment of the electrospun fibers to stabilize them against water can be dispensed with.

It is an object of the present invention to provide a process for electrospinning aqueous polymer dispersions, with which polymer fibers with structural and/or mechanical properties optimized compared to the polymer fibers disclosed in WO 2006/089522A1 can be obtained.

The object is achieved by the provision of a process for producing polymer fibers, in which a colloidal dispersion of at least one essentially water-insoluble polymer is electrospun in an aqueous medium at from 5 to 90° C.

In the process according to the invention, the at least one essentially water-insoluble polymer has a glass transition temperature T_{g}, measured by means of DSC, which is within a range of from not more than 15° C. above to not more than 15° C. below the process temperature.

The process according to the invention can afford fibers with a high water stability, which feature good mechanical stability. It is possible by the process according to the invention to produce nano- and mesofibers having a diameter of less than 1 μm from aqueous dispersions, such that the use of nonaqueous toxic, combustible, irritant, explosive and/or corrosive solvents can be avoided. Since the fibers produced by the process according to the invention are formed from essentially water-insoluble polymers, a subsequent process step for water stabilization of the fibers is not required.

In the process according to the invention for producing the polymer fibers, a colloidal dispersion of at least one essentially water-insoluble polymer is electrospun in an aqueous medium. In the context of the present invention, essentially water-insoluble polymers are especially polymers having a solubility in water of less than 0.1% by weight.

In agreement with textbook knowledge, a dispersion in the context of the present invention refers to a mixture of at least two mutually immiscible phases, at least one of the two phases being liquid. Depending on the state of matter of the second or further phase, dispersions are divided into aerosols, emulsions and suspensions, the second or further phase being gaseous in the case of aerosols, liquid in the case of emulsions and solid in the case of suspensions. In the process according to the invention, preference is given to using suspensions. The colloidal polymer dispersions to be used with preference in accordance with the invention are also referred to as latex in technical terms.

The glass transition temperature T_{g} is the temperature at which completely or partly amorphous polymers are converted from the liquid or rubber-elastic, flexible state to the glassy or half-elastic, brittle state. It constitutes an important parameter for plastics and is specific to each plastic.

The glass transition temperature T_{g} can be measured, for example, with the aid of dynamical mechanical analysis (DMA), of dynamic scanning calorimetry (DSC) or of dilatometry. The values mentioned in the present application for the glass transition temperatures of different polymers have been taken from the Polymer Handbook (4th edition), edited by: Brandrup, J.; Immergut, Edmund H.; Grulke, Eric A.; Abe, Akihiro; Bloch, Daniel R. © 1999; 2005 John Wiley & Sons or—where they are not mentioned in the Polymer Handbook—determined by means of DSC (DIN 53765, ISO 11357-2).

According to the invention, the at least one essentially water-insoluble polymer has a glass transition temperature T_{g} which is within a range from not more than 15° C. above to not more than 15° C. below the process temperature, preferably within a range from not more than 10° C. above to not more than 10° C. below the process temperature, more preferably within a range of from not more than 5° C. above to not more than 5° C. below the process temperature.

It has been found that, surprisingly, with the aid of the process according to the invention, polymer fibers which have excellent mechanical stability and good elastic properties and no brittleness are obtained when the aforementioned conditions are maintained in the process according to the invention, i.e. electrospinning is effected at a process temperature of from 5 to 90° C. and at least one essentially water-insoluble polymer which has a glass transition temperature T_{g} which is in the range from not more than 15° C. above to not more than 15° C. below the glass transition temperature is used.

Without being bound to a theory, it is assumed that, with the aid of the process according to the invention, polymerfibers with outstanding properties are obtained because the process temperature of the polymers is within the range of the film formation temperature (MFFT) of the polymers. It is known to those skilled in the art that the film formation temperature corresponds roughly to the T_{g} or is slightly below this value (Emulsion polymerization and emulsion polymers, edited by P. Lovell, M. El-Aasser, J. Wiley, 1997; Waterbased acrylates for decorative coatings, authors M. Schwartz, R. Baumstark, 2001)).

According to the present invention, at least one essentially water-insoluble polymer is understood to mean both individual homo- and copolymers and mixtures of different homo- or copolymers. In addition, the term “at least one essentially water-insoluble polymer” is also understood to mean polymer mixtures which, as well as the at least one homo- or copolymer, comprise, for example, a plasticizer. It is known to those skilled in the art that the glass transition temperature (and the film formation temperature) of polymers can be lowered by addition of a plasticizer or raised by crosslinking of the polymer. Suitable plasticizers are generally dependent on the homo- or copolymer used. Customary plasticizers are, for example, phthalic esters, polyvinyl alcohols or aliphatic polyethers. Suitable plasticizers are additionally, for example, hexahydrophthalic esters. In principle, it is known to those skilled in the art which plasticizers are suitable for which polymers or polymer mixtures.

In a preferred embodiment of the process according to the invention, at least one essentially water-insoluble polymer having a glass transition temperature T_{g} within a range of at least −10° C. and at most 105° C., preferably of at least −5° C. and at most 100° C., more preferably of at least 0° C. and at most 95° C. is thus used, the glass transition temperature T_{g} in the context of the present application being understood to mean the actual glass transition temperature of the corresponding polymer or a glass transition temperature of a corresponding polymer lowered by the use of a plasticizer.

The process according to the invention is performed at a temperature of from 5 to 90° C. Preference is given to effecting the inventive electrospinning process at a temperature of from 10 to 70° C., more preferably from 15 to 50° C. The process temperature depends upon factors including the essentially water-insoluble polymer used, since the essentially water-insoluble polymer, according to the invention, has a glass transition temperature T_{g} in the range from not more than 15° C. above to not more than 15° C. below the process temperature.

In the context of the present invention, the process temperature is understood to mean the ambient temperature during the electrospinning process between spinning source and counterelectrode. The spinning source may be, for example, a cannula (e.g. a needle) or roller.

In principle, the colloidal polymer dispersions used in accordance with the invention may be produced by all processes known for this purpose to those skilled in the art. Preference is given to producing the colloidal dispersions by emulsion polymerization of suitable monomers to obtain the corresponding latices. In general, the latex obtained by emulsion polymerization is used directly in the process according to the invention without further workup. The colloidal polymer dispersions used may, for example, also be so-called secondary dispersions. These are produced from already prepared polymers by dispersion in an aqueous medium. In this way, it is possible, for example, to produce dispersions of polyethylene or polyesters.

The aqueous medium in which the essentially water-insoluble polymer is present is generally water. The aqueous medium may, as well as water, comprise further additives, for example additives which are used to produce a latex in the emulsion polymerization of suitable monomers. Suitable additives are known to those skilled in the art.

In principle, it is possible in the process according to the invention to use all essentially water-insoluble polymers known to those skilled in the art, provided that they have the above-specified glass transition temperature—if appropriate by virtue of addition of plasticizers or crosslinkers.

Suitable essentially water-insoluble polymers are, for example, selected from the group consisting of homo- and copolymers of aromatic vinyl compounds, homo- and copolymers of alkyl acrylates, homo- and copolymers of alkyl methacrylates, homo- and copolymers of α-olefins, homo- and copolymers of aliphatic dienes, homo- and copolymers of vinyl halides, homo- and copolymers of vinyl acetates, homo- and copolymers of acrylonitriles, homo- and copolymers of urethanes, homo- and copolymers of vinylamides, and copolymers formed from two or more of the monomer units forming the aforementioned polymers.

Suitable homo- and copolymers of aromatic vinyl compounds are homo- and copolymers based on poly(alkyl)styrenes, e.g. polystyrene, poly-α-methylstyrene, styrene/alkyl acrylate copolymers, especially styrene/n-butyl acrylate copolymers, styrene/alkyl methacrylate copolymers, acrylonitrile/styrene/acrylic ester copolymers (ASA), styrene/acrylonitrile copolymers (SAN), acrylonitrile/butadiene/styrene copolymers (ABS), styrene/butadiene copolymers (SB).

Suitable polyalkyl acrylates are, for example, polyalkyl acrylates based on isobutyl acrylate, tert-butyl acrylate, ethyl acrylate. When copolymers which comprise polyalkyl acrylates are used, methyl acrylate, 2-hydroxyethyl acrylate, hydroxypropyl acrylate and n-butylacrylate are additionally suitable.

Suitable poly(alkyl) methacrylates are, for example, polyalkyl methacrylates based on n-butyl methacrylate, isobutyl methacrylate, tert-butyl methacrylate, ethylhexyl methacrylate, glycidyl methacrylate, methyl methacrylate, n-propyl methacrylate, i-propyl methacrylate, n-pentyl methacrylate. When copolymers which comprise poly(alkyl) methacrylates are used, for example, hydroxypropyl methacrylate is additionally suitable.

Suitable homo- and copolymers of α-olefins are, for example, polyethylene, polypropylene, polyethylene/propylene) (EPDM) and olefin/vinyl acetate copolymers, e.g. ethylene/vinyl acetate copolymers, and olefin/acrylate copolymers, e.g. ethylene/acrylate copolymers.

Suitable homo- and copolymers of vinyl halides are, for example, polyvinyl chloride, polytrichloroethylene, polytrifluoroethylene or polyvinyl fluoride.

Further suitable homo- and copolymers are homo- and copolymers based on melamine-containing compounds, 1,3-butadiene, isoprene or vinyl alcohols (provided that they are essentially water-insoluble and have a T_{g} within the inventive range).

In addition, copolymers of acrylates, methacrylates, vinyl alcohols, polyalcohols and/or vinylaromatics with acrylic acid, maleic acid, fumaric acid, methacrylic acid and/or itaconic acid may be used (provided that they are essentially water-insoluble and have a T_{g} within the inventive range).

The glass transition temperature of polymers can be taken from textbooks or handbooks known to those skilled in the art (for example Polymer Handbook (4th edition), edited by: Brandrup, J.; Immergut, Edmund H.; Grulke, Eric A.; Abe, Akihiro; Bloch, Daniel R. © 1999; 2005 John Wiley & Sons). The glass transition temperature of random copolymers or homogeneous mixtures of different polymers can be calculated with knowledge of the glass transition temperatures of the particular homopolymers (which can be taken from suitable textbooks) by the following Fox formula (T. G. Fox, Bull. Am. Phys. Soc., 1, 123 (1956 known to those skilled in the art):

1/T_{g}=w₁/T_{g}1+w₂/T_{g}2+ . . . +wₙ/T_{g}n

in which:
w1, w2, wn is the mass fraction (% by weight/100) of particular monomers n,
T_{g}1, T_{g}2, T_{g}n are the glass transition temperatures in Kelvin of the particular homopolymers of the monomers n,
T_{g} is the glass transition temperature of the corresponding random copolymer or of the homogeneous mixture of different (co)polymers.

Preferably, the at least one essentially water-insoluble polymer is selected from the group consisting of polystyrene, poly-α-methylstyrene, styrene/alkyl acrylate copolymers, especially styrene/n-butyl acrylate copolymers, styrene/alkyl methacrylate copolymers, α-methylstyrene/alkyl acrylate copolymers, α-methylstyrene/alkyl methacrylate copolymers, poly(alkyl) methacrylates, polyethylene, ethylene/vinyl acetate copolymers, ethylene/acrylate copolymers, polyvinyl chloride, polyalkylnitrile and polyvinyl acetate, polyurethanes, styrene-butadiene copolymers and styrene-acrylonitrile-butadiene copolymers.

More preferably, the at least one essentially water-insoluble polymer is selected from styrene/alkyl acrylate copolymers, especially styrene/n-butyl acrylate copolymers, and styrene/alkyl methacrylate copolymers.

Suitable alkyl acrylates for use in the styrene/alkyl acrylate copolymers are, for example, n-butyl acrylate, isobutyl acrylate, tert-butyl acrylate, ethyl acrylate, 2-ethylhexyl acrylate, n-hexyl acrylate, 2-hydroxyethyl acrylate, hydroxypropyl acrylate, lauryl acrylate, methyl acrylate and n-propyl acrylate, preference being given to n-butyl acrylate, ethyl acrylate, methyl acrylate and 2-ethylhexyl acrylate.

Suitable alkyl methacrylates for use in the styrene/alkyl methacrylate copolymers are, for example, n-butyl methacrylate, isobutyl methacrylate, tert-butyl methacrylate, ethylhexyl methacrylate, glycidyl methacrylate, hydroxy methacrylate, hydroxypropyl methacrylate, n-propyl acrylate, i-propyl acrylate and n-pentyl methacrylate, preferably n-butyl methacrylate, ethylhexyl methacrylate and methyl methacrylate.

The proportion of the different monomer units in the aforementioned copolymers is variable (and dependent upon the desired glass transition temperature). In the case of the styrene/n-butyl acrylate copolymers, the proportion of styrene in the copolymers is generally from 30 to 100% by weight, preferably from 40 to 95% by weight, and the proportion of n-butyl acrylate is from 0 to 70% by weight, preferably from 5 to 60% by weight, where the sum total of styrene and alkyl acrylate or alkyl methacrylate is 100% by weight.

The aforementioned essentially water-insoluble polymers are commercially available or can be prepared by processes known to those skilled in the art. In a preferred embodiment of the present invention, essentially water-insoluble polymers which are prepared by emulsion polymerization are used. The polymer latex obtained in the emulsion polymerization can be used directly as the colloidal dispersion in the electrospinning process according to the invention.

The at least one essentially water-insoluble polymer can be used in the colloidal dispersion in uncrosslinked, partly crosslinked or fully crosslinked form, provided that its solubility in water is less than 0.1% by weight.

In one embodiment of the present invention, the at least one essentially water-insoluble polymer used in the colloidal dispersion in the process according to the invention is partly or fully crosslinked, the crosslinking being effected by intraparticulate crosslinking.

The intraparticulate crosslinking of the at least one essentially water-insoluble polymer is effected generally by adding at least one crosslinker (crosslinking monomer) during the preparation of the essentially water-insoluble polymer by polymerization of the corresponding monomers to the monomer mixture. Suitable crosslinkers and suitable amounts of crosslinker are known to those skilled in the art and are specified, for example, in Emulsion polymerization and emulsion polymers, edited by P. Lovell, M. El-Aasser, J. Wiley, 1997. Suitable crosslinkers are generally monomers which comprise two, and if appropriate even three or more, ethylenically double bonds capable of copolymerization, which are not conjugated in the 1,3-position. Suitable crosslinkers are compounds having two or more ethylenically unsaturated groups, for example diacrylates or dimethacrylates of at least dihydric saturated alcohols, for example ethylene glycol diacrylate, ethylene glycol dimethacrylate, 1,2-propylene glycol diacrylate, 1,2-propylene glycol dimethacrylate, 1,4-butanediol diacrylate, 1,4-butanediol dimethacrylate, hexanediol diacrylate, hexanediol dimethacrylate, neopentyl glycol diacrylate, neopentyl glycol dimethacrylate, 3-methylpentanediol diacrylate and 3-methylpentanediol dimethacrylate. The acrylic and methacrylic esters of alcohols having more than 2 OH groups may also be used as crosslinkers, for example trimethylolpropane triacrylate or trimethylolpropane trimethacrylate. A further class of crosslinkers is that of diacrylates or dimethacrylates of polyethylene glycols or polypropylene glycols having molecular weights of in each case from 200 to 9000.

Apart from the homopolymers of ethylene oxide or propylene oxide, it is also possible to use block copolymers of ethylene oxide and propylene oxide, or copolymers of ethylene oxide and propylene oxide which comprise the ethylene oxide and propylene oxide units in random distribution. The oligomers of ethylene oxide or propylene oxide are also suitable for the preparation of the crosslinkers, for example diethylene glycol diacrylate, diethylene glycol dimethacrylate, triethylene glycol diacrylate, triethylene glycol dimethacrylate, tetraethylene glycol diacrylate and/or tetraethylene glycol dimethacrylate.

Suitable crosslinkers are also vinyl acrylate, vinyl methacrylate, vinyl itaconate, divinyl adipate, butanediol divinyl ether, trimethylolpropane trivinyl ether, allyl acrylate, allyl methacrylate, pentaerithrityl triallyl ether, triallylsucrose, pentaallylsucrose, methylene-bis(meth)acrylamide, divinylethyleneurea, divinylpropyleneurea, divinylbenzene, divinyldioxane, triallyl cyanurate, tetraallylsilane, tetravinylsilane, and bis- or polyacryloylsiloxanes (e.g. Tegomers® from Goldschmidt AG).

Preferentially suitable crosslinkers are, for example, divinyl compounds such as divinylbenzene, diallyl and triallyl compounds such as diallyl maleate, diallyl fumarate, diallyl phthalate, triallyl cyanurate or triallyl isocyanurate, polyallyl compounds such as polyallyl methacrylate, allyl esters of acrylic and methacrylic acid, dihydrodicyclopentadienyl acrylate (DCPA), divinyl esters of dicarboxylic acids, such as of succinic acid and of adipic acid, diallyl ether- and divinyl ether-functional alcohols, such as those of ethylene glycol and of butane-1,4-diol, for example ethylene glycol dimethacrylate, pentaerythrityl tetraacrylate. In addition, the acrylic ester of tricyclodecenyl alcohol is suitable as a crosslinker (see DE-A 12 60 135).

The amount of suitable crosslinker is generally from 0.01 to 20% by weight, preferably from 0.01 to 10% by weight.

The resulting polymer may be fully crosslinked, i.e. all (100%) of the groups of the polymer suitable for crosslinking are crosslinked, or partly crosslinked, i.e. only some (from 50 to 100%, preferably from 60 to 98%) of the groups of the polymer suitable for crosslinking are crosslinked.

Particularly good results are obtained in the process according to the invention with colloidal polymer suspensions wherein the average weight-average particle diameter of the at least one essentially water-insoluble polymer is generally from 1 nm to 2.5 μm, preferably from 10 nm to 1.2 μm, more preferably from 15 nm to 1 μm. The average weight-average particle diameter of latex particles produced by emulsion polymerization, which are used in a preferred embodiment in the process according to the invention, is generally from 30 nm to 2.5 μm, preferably from 50 nm to 1.2 μm (determined according to W. Scholtan and H. Lange in Kolloid-Z. und Polymere 250 (1972), p. 782-796, by means of an ultracentrifuge). Very particular preference is given to using colloidal polymer suspensions, especially latices, in which the polymer particles have a weight-average particle diameter of from 20 nm to 500 nm, very especially preferably from 30 nm to 250 nm.

The colloidal suspension used with preference in accordance with the invention may comprise particles with monomodal particle size distribution of the polymer particles or with bi- or polymodal particle size distribution. The terms mono-, bi- and polymodal particle distribution are known to those skilled in the art.

When the latex to be used in accordance with the invention is based on two or more monomers, the latex particles may be arranged in any manner known to those skilled in the art. Merely by way of example, mention is made of particles with gradient structure, core-shell structure, salami structure, multicore structure, multilayer structure and raspberry morphology.

The term “latex” should also be understood to mean the mixture of two or more latices. The mixture can be prepared by all processes known for this purpose, for example by mixing of two latices at any time before the spinning.

In a further preferred embodiment of the present invention, the colloidal dispersion comprises, as well as the at least one water-insoluble polymer, additionally at least one water-soluble polymer, water-soluble polymer being understood in the context of the present invention to mean a polymer having a solubility in water of at least 0.1% by weight.

Without being bound to a theory, the at least one water-soluble polymer which is preferably present additionally in the colloidal dispersions may serve as so-called template polymer. With the aid of the template polymer, the fiber formation from the colloidal polymer dispersion (electrospinning) is favored further over spraying (electrospraying). The template polymer serves as a kind of “thickener” for the essentially water-insoluble polymers of the colloidal dispersion.

After the production of the polymer fibers by the process according to the invention, the water-soluble polymer, in a preferred embodiment of the process according to the invention, is removed, for example, by washing/extraction with water.

After the water-soluble polymers have been removed, water-insoluble polymer fibers, especially nano- and microfibers, are obtained without disintegration of the polymer fibers.

The water-soluble polymer may be a homopolymer/copolymer, block polymer, graft copolymer, star polymer, highly branched polymer, dendrimer or a mixture of two or more of the aforementioned polymer types. According to the findings of the present invention, the addition of at least one water-soluble polymer does not only accelerate/promote the fiber formation. Instead, the quality of the resulting fibers is also significantly improved.

In principle, all water-soluble polymers known to those skilled in the art may be added to the colloidal dispersion of at least one essentially water-insoluble polymer in an aqueous medium, particularly good results being achieved especially with water-soluble polymers selected from the group consisting of polyvinyl alcohol, polyvinylformamide, polyvinylamine, polycarboxylic acid, (polyacrylic acid, polymethacrylic acid)polyacrylamide, polyitaconic acid, poly(2-hydroxyethyl acrylate), poly(N-isopropylacrylamide), polysulfonic acid, (poly(2-acrylamido-2-meyhyl-1-propanesulfonic acid) or PAMPS), polymethacrylamide, polyalkylene oxides, for example polyethylene oxides; poly-N-vinylpyrrolidone; hydroxymethylcelluloses; hydroxyethylcelluloses; hydroxypropylcelluloses; carboxymethylcelluloses; maleic acids; alginates; collagens; gelatin, poly(ethyleneimine), polystyrenesulfonic acid; combinations formed from two or more of the monomer units forming the aforementioned polymers, copolymers formed from two or more of the monomer units forming the aforementioned polymers, graft copolymers formed from two or more of the monomer units forming the aforementioned polymers, star polymers formed from two or more of the monomer units forming the aforementioned polymers, highly branched polymers formed from two or more of the monomer units forming the aforementioned polymers, and dendrimers formed from two or more of the monomer units forming the aforementioned polymers.

In a preferred embodiment of the present invention, the water-soluble polymer is selected from polyvinyl alcohol, polyethylene oxides, polyvinylformamide, polyvinylamine and poly-N-vinylpyrrolidone.

The aforementioned water-soluble polymers are commercially available or can be prepared by processes known to those skilled in the art.

Irrespective of the embodiment, the solids content of the colloidal dispersion to be used in accordance with the invention—based on the total weight of the dispersion—is preferably from 5 to 60% by weight, more preferably from 10 to 50% by weight and most preferably from 10 to 40% by weight.

In the further embodiment of the present invention, the colloidal dispersion comprising at least one essentially water-insoluble polymer and if appropriate at least one water-soluble polymer in an aqueous medium to be used in the process according to the invention comprises, based on the total weight of the dispersion, from 0 to 25% by weight, more preferably from 0.5 to 20% by weight and most preferably from 1 to 15% by weight of at least one water-soluble polymer.

The colloidal dispersion used in accordance with the invention thus comprises, in a preferred embodiment, based in each case on the total amount of the colloidal dispersion,
i) from 5 to 60% by weight, preferably from 10 to 50% by weight, more preferably from 10 to 40% by weight, of at least one essentially water-insoluble polymer,
ii) from 0 to 25% by weight, preferably from 0.5 to 20% by weight, more preferably from 1 to 15% by weight, of at least one water-soluble polymer, and
iii) from 15 to 95% by weight, preferably from 30 to 89.5% by weight, more preferably from 45 to 89% by weight, of water,
   where the sum total of the components specified under i), ii) and iii) is 100% by weight.

The weight ratio of essentially water-insoluble polymer to the water-soluble polymer which is preferably present in the colloidal dispersion is dependent upon the polymers used. For example, the essentially water-insoluble polymer and the water-soluble polymer used with preference may be used in a weight ratio of from 300:1 to 1:5, preferably from 100:1 to 1:2, more preferably from 40:1 to 1:1.5.

The colloidal dispersion to be used in accordance with the invention can be electrospun by all methods known to those skilled in the art, for example by extrusion of the dispersion, preferably of the latex, under low pressure through a cannula bonded to one pole of a voltage source toward a counterelectrode arranged at a distance from the cannula exit. The distance between the cannula and the counterelectrode functioning as the collector and the voltage between the electrodes are preferably adjusted such that an electrical field of preferably from 0.1 to 9 kV/cm, more preferably from 0.3 to 6 kV/cm and most preferably from 0.5 to 3 kV/cm is formed between the electrodes.

Good results are obtained especially when the internal diameter of the cannula is from 50 to 500 μm.

According to the end use of the fibers produced, it may be appropriate subsequently to chemically bond them to one another or, for example, to crosslink them with one another by means of a chemical mediator. This allows, for example, the stability of a fiber layer formed by the fibers to be improved further, especially in relation to the water resistance and thermal stability.

The present invention further provides fibers, especially nano fibers and mesofibers, which are obtainable by the process according to the invention. The inventive fibers are notable in that, owing to the inventive selection of the essentially water-insoluble polymers, in relation to the process temperature, they have optimized structural and/or mechanical properties, especially with regard to uniformity, compactness, elasticity and mechanical and thermal stability, compared to fibers which comprise polymers which have glass transition temperatures of more than +/−15° C. above or below the process temperature of the electrospinning process.

The diameter of the inventive fibers is preferably from 10 nm to 50 μm, more preferably from 50 nm to 2 μm and most preferably from 100 nm to 1 μm. The length of the fibers depends on the end use and is generally from 50 μm up to several kilometers.

A significant aspect with regard to the use of the inventive polymer fibers is—as well as good structural and mechanical properties and thermal stability—the fiber diameter of the inventive polymer fibers. The fiber diameter has a significant influence, for example, on the porosity of filter media produced from the inventive polymer fibers, and on the visual and sensory properties of, for example, textile fabrics such as fleeces which are produced from the inventive fibers. It has been found that the fiber diameter, which depends upon factors including the process parameters such as flow rate and the field strength of the electrical field and, if appropriate, on the diameter of the cannula used, is additionally dependent upon the material properties, for example the diameter of the polymer particles used, of the essentially water-insoluble polymers used in the electrospinning process according to the invention and the ratio of the components used in the electrospinning process relative to one another.

At constant voltage, flow rate and a constant cannula diameter, the fiber diameter is proportional to the average weight-average particle diameter of the essentially water-insoluble polymer used in the process according to the invention. By varying the average weight-average particle diameter of the at least one essentially water-insoluble polymer, it is thus possible to influence the diameter of the inventive polymer fibers.

It is thus possible through selection of the diameter of the polymer particles used to control the fiber diameter of the inventive polymer fibers and to produce, in a controlled manner, polymer fibers with specific fiber diameters. Suitable particle sizes (average weight-average particle diameters) of essentially water-insoluble polymer are specified above. Very particularly preferred average weight-average particle diameters are from 10 to 500 nm, preferably from 10 to 200 nm, more preferably from 10 to 100 nm.

The inventive polymer fibers are suitable for further processing, for example by weaving of the inventive polymer fibers to textile fabrics.

The present invention therefore further provides textile fabrics comprising polymer fibers according to the present invention. Preferred embodiments of the inventive polymer fibers are specified above. The textile fabrics may be formed exclusively from the inventive polymer fibers or, as well as the inventive polymer fibers, comprise conventional fibers known to those skilled in the art. It is, for example, possible that the inventive textile fabric is formed from conventional fibers and has a layer (sheet) which comprises the inventive polymer fibers. It is additionally possible, for example, that the textile fabric is formed from a mixture of conventional fibers and inventive polymer fibers.

These textile fabrics or else the inventive polymer fibers themselves may be used for numerous applications. Preferred applications are selected from the group consisting of use in the following applications: filters or filter parts, nonwovens, fleeces, especially for gas, air and/or liquid filtration, industrial or domestic textiles or constituents or coatings of such textiles, such as wiping cloths, cosmetic cloths, clothing, medical textiles, etc., coatings or constituents of packaging, for example coatings of paper, for use in wound healing, or as a wound covering, for transport or for release of active ingredients and effect substances, for example in medicine, agriculture or cosmetics, cell culture carriers, catalyst supports, sensors or components thereof, acoustic dampers, precursors for producing other fibers (organic, inorganic), and also continuous layers, for example films, as additives for polymers, coatings for improving sensory properties, optical properties, for example reflection properties, and appearance, membrane production, and adsorbers and absorbers of solid, liquid and gaseous media.

In most of these applications, the inventive polymer fibers are used in the form of textile fabrics. The production of textile fabrics from the inventive polymer fibers is known to those skilled in the art and can be effected by all customary processes. However, it is also possible to use the inventive fibers themselves, for example as additives (fillers) for polymers or as precursors for producing other fibers and continuous layers.

Further aims, features, advantages and possible uses of the invention are evident from the description of working examples which follows and the drawings. All features described and/or illustrated in image form, alone or in any combination, form the subject matter of the invention, irrespective of their combination in the claims or the claims to which they refer back.

The figures show:

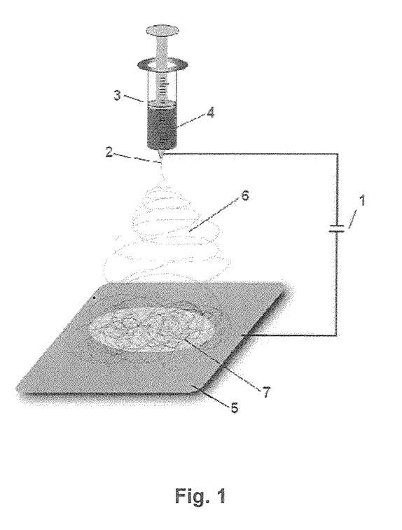

FIG. 1 a schematic illustration of an apparatus suitable for performing the electrospinning process according to the invention,

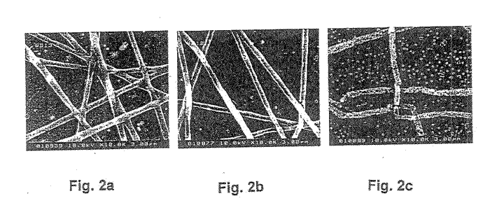

FIG. 2 scanning electron micrograph of the fibers obtained according to examples 1, 2 and C3 with an essentially water-insoluble polymer having a T_{g} of 6.8° C. (FIG. 2a), a T_{g} of 27.2° C. (FIG. 2b) and a T_{g} of 64.2° C. (FIG. 2c).

The apparatus for electrospinning which is suitable for performing the process according to the invention and is shown in FIG. 1 comprises a syringe 3 which is provided at its tip with a capillary die 2 which is connected to one pole of a voltage source 1 and is for accommodating the inventive colloidal dispersion 4. Opposite the exits of the capillary die 2, at a distance of about 20 cm, is arranged a square counterelectrode 5 connected to the other pole of the voltage source 1, which functions as the collector for the fibers formed.

During the operation of the apparatus, a voltage of 30 kV is set at the electrodes 2, 5, and the colloidal dispersion 4 is discharged under a low pressure through the capillary die 2 of the syringe 3. Owing to the electrostatic charge of the essentially water-insoluble polymers in the colloidal dispersion which results from the strong electrical field of from 0.1 to 10 kV/cm, a material flow directed toward the counterelectrode 5 forms, and solidifies on the way to the counterelectrode 5 with fiber formation 6, as a consequence of which fibers 7 with diameters in the micrometer and nanometer range are deposited on the counterelectrode 5.

With the aforementioned apparatus, in accordance with the invention, a colloidal dispersion of at least one essentially water-insoluble polymer and of at least one nonionic surfactant in an aqueous medium is electrospun.

The solids content within the dispersion is determined gravimetrically by means of a Mettler Toledo HR73 halogen moisture analyzer, by heating approx. 1 ml of the sample to 200° C. within 2 minutes and drying the sample to constant weight and then weighing it.

The mean particle size is the weight average d₅₀, determined by means of an analytical ultracentrifuge (according to W. Scholtan and H. Lange in Kolloid-Z. and Polymere 250 (1972), p. 782-796).

The size, i.e. the diameter and the length of the fibers, is determined by evaluating electron micrographs.

1. Preparation of the Colloidal Dispersions

1.1 General Method

The polymer latex used in the examples which follow comprises a styrene/n-butyl acrylate copolymer in an amount of approx. 40% by weight (example 1: 38.9% by weight, example 2: 37.5% by weight, example C3: 38.6% by weight), based on the total weight of the polymer latex. The mean particle size (weight average, d₅₀) is 131 nm (example 1), 137 nm (example 2) or 149 nm (example C3). The copolymers are formed from 35% by weight of styrene and 65% by weight of n-butyl acrylate (example 1), 50% by weight of styrene and 50% by weight of n-butyl acrylate (example 2), and 70% by weight of styrene and 30% by weight of n-butyl acrylate (example C3). In the present process, example C3 constitutes a comparative example. While the copolymer of example 1 has a T_{g} of 6.8° C., and the copolymer in example 2 has a T_{g} of 27.2° C., the copolymer according to example C3 has a T_{g} of 64.2° C. The process is performed at 19° C., such that the T_{g} of the copolymer according to example C3 is outside the range claimed.

The polymer latices comprising the copolymers mentioned are produced by customary processes known to those skilled in the art. This process typically affords a polymer latex having a content of styrene/n-butyl acrylate copolymer of >30% by weight, which is subsequently diluted to the desired concentration with water.

The water-soluble polymer used is poly(vinyl alcohol) (PVA) having a weight-average molecular weight (M_{W}) of 145,000 g/mol, which has been hydrolyzed to an extent of 99% (MOWIOL® 28-99 from Kuraray Specialities Europe KSE).

The colloidal dispersions used for electrospinning are prepared by mixing a latex comprising a styrene/n-butyl acrylate copolymer with water. The solids content of the dispersion to be spun is 19.4% by weight. The aforementioned polyvinyl alcohol is added to the polymer latex in aqueous solution (10% by weight), such that the colloidal dispersion to be spun comprises approx. 4.8% by weight of PVA and the weight ratio of styrene/n-butyl acrylate copolymer to polyvinyl alcohol (PVA) in the mixture is approx. 80:20.

In a comparative experiment, a corresponding colloidal dispersion based on polystyrene (T_{g}=107° C.) is spun (example C4).

1.2 Example Dispersions

Table 1 summarizes the colloidal dispersions to be spun:

| | | Amount of PVA²⁾ | T_{g} |
|---|---|---|---|
| Example | Amount of copolymer²⁾ | [% by weight] | [° C.]³⁾ |
| 1 | 19.4% by weight | 4.8% by weight | 6.8° C. |
| 2 | 19.4% by weight | 4.8% by weight | 27.2° C. |
| C3¹⁾ | 19.4% by weight | 4.8% by weight | 64.2° C. |
| C4¹⁾ | 17.9 | 4.5 | 107° C. |

¹⁾Comparative
²⁾Styrene/n-butyl acrylate copolymer according to examples 1, 2, C3 and polystyrene according to example C4 based on the total weight of the dispersion
³⁾The modulus of elasticity was measured by means of a “Minimat microtensile tester” (Polymer Laboratories Ltd., UK) on samples of length 10 mm and a distance of 5 mm at room temperature with a speed of 0.2 mm/min.

2. Electrospinning of the Dispersions Prepared

The colloidal dispersions 1, 2, C3 and C4 prepared according to number 1 are electrospun in the apparatus shown in FIG. 1.

The dispersion is conveyed at a temperature of 19° C. through a syringe 3 with a capillary die 2 having an internal diameter of 0.3 mm provided at its tip with a sample feed rate of 0.5 ml/h, the distance between electrodes 2, 5 being 200 mm and a voltage of 30 kV being applied between the electrodes. To remove the water-soluble polymer, the resulting fibers are treated with water at room temperature for 17 hours.

FIG. 2 shows the scanning electron micrographs of the fibers produced from the colloidal dispersions 1 (left, FIG. 2a), 2 (middle, FIG. 2b) and C3 (right, FIG. 2c).

As is evident from FIG. 2, when copolymers which have a T_{g} within a range of not more than 15° C. above to not more than 15° C. below the process temperature are used, more homogeneous polymer fibers are obtained (FIG. 2a, FIG. 2b) than when copolymers whose T_{g} is outside the range specified are used (FIG. 2c).

The modulus of elasticity of the inventive fibers according to example 1 is 9 MPa, while the modulus of elasticity of fibers according to example C4 is 1.2 MPa. The inventive fibers are thus notable for a high elasticity.

List of Reference Numerals
1 Voltage source
2 Capillary die
3 Syringe
4 Colloidal dispersion
5 Counterelectrode
6 Fiber formation

1. A process for producing polymer fibers by electrospinning a colloidal dispersion of at least one essentially water-insoluble polymer in an aqueous medium at a process temperature of from 5 to 90° C., wherein the at least one essentially water-insoluble polymer has a glass transition temperature T_{g}, measured by means of DSC, which is within a range of from not more than 15° C. above to not more than 15° C. below the process temperature.

2. The process according to claim 1, wherein the at least one essentially water-insoluble polymer has a T_{g} within a range from at least −10° C. to not more than 105° C., the T_{g} of the polymer being within a range of from not more than 15° C. above to not more than 15° C. below the process temperature.

3. The process according to claim 1, wherein the at least one essentially water-insoluble polymer is selected from the group consisting of homo- and copolymers of aromatic vinyl compounds, homo- and copolymers of alkyl acrylates, homo-and copolymers of alkyl methacrylates, homo- and copolymers of α-olefins, homo- and copolymers of aliphatic dienes, homo- and copolymers of vinyl halides, homo- and copolymers of vinyl acetates, homo- and copolymers of acrylonitriles, homo- and copolymers of urethanes, homo- and copolymers of vinylamides, and copolymers formed from two or more of the monomer units forming the aforementioned polymers.

4. The process according to claim 3, wherein the at least one essentially water-insoluble polymer is selected from styrene/alkyl acrylate copolymers and styrene/alkyl methacrylate copolymers.

5. The process according to claim 1, wherein the at least one essentially water-insoluble polymer is used in the colloidal dispersion in uncrosslinked, partly crosslinked or fully crosslinked form.

6. The process according to claim 1, wherein the average weight average particle diameter of the at least one essentially water-insoluble polymer is between 1 mm and 2.5 μm.

7. The process according to claim 1, wherein the colloidal dispersion additionally comprises at least one water-soluble polymer having a solubility in water of at least 0.1% by weight.

8. The process according to claim 7, wherein the water-soluble polymer is selected from the group consisting of homopolymers, copolymers, graft copolymers, star polymers, highly branched polymers and dendrimers.

9. The process according to claim 7, wherein the water-soluble polymer is selected from the group consisting of polyvinyl alcohol, polyvinylformamide, polyvinylamine, polycarboxylic acid, polyacrylamide, polyitaconic acid, poly(2-hydroxyethyl aorylate), poly(N-isopropylacrylamide), polysulfonic acid, polymethacrylamide, polyalkylene oxides; poly-N-vinylpyrrolidone; hydroxymethylcelluloses; hydroxyethylcelluloses; hydroxypropylcelluloses; carboxymethylcelluloses; maleic acids; alginates; collagens; gelatin, poly(ethyleneimine), polystyrenesulfonic acid; combinations formed from two or more of the monomer units forming the aforementioned polymers, copolymers formed from two or more of the monomer units forming the aforementioned polymers, graft copolymers formed from two or more of the monomer units forming the aforementioned polymers, star polymers formed from two or more of the monomer units forming the aforementioned polymers, highly branched polymers formed from two or more of the monomer units forming the aforementioned polymers, and dendrimers formed from two or more of the monomer units forming the aforementioned polymers.

10. The process according to claim 1, wherein the solids content of the colloidal dispersion, based on the total weight of the dispersion, is from 5 to 60% by weight.

11. The process according to claim 1, wherein the colloidal dispersion, based on the total weight of the dispersion, comprises from 0 to 25% by weight.

12. A fiber obtainable by a process according to claim 1.

13. The fiber according to claim 12, which has a diameter of from 10 nm to 50 μm.

14. The fiber according to claim 12, which has a length of at least 50 μm.

15. A textile fabric comprising fibers according to claim 12.

16. The use of fibers according to claim 12 for use in the following applications: filters or filter parts, nonwovens, fleeces, industrial or domestic textiles or constituents or coatings of such textiles, medical textiles, coatings or constituents of packaging, for use in wound healing, or as a wound covering, for transport or for release of active ingredients and effect substances, cell culture carriers, catalyst supports, sensors or components thereof, acoustic dampers, precursors for producing other fibers, and also continuous layers, as additives for polymers, coatings for improving sensory properties, optical properties and appearance, membrane production, and adsorbers and absorbers of solid, liquid and gaseous media.

17. The process according to claim 2, wherein the at least one essentially water-insoluble polymer is selected from the group consisting of homo- and copolymers of aromatic vinyl compounds, homo- and copolymers of alkyl acrylates, homo-and copolymers of alkyl methacrylates, homo- and copolymers of α-olefins, homo- and copolymers of aliphatic dienes, homo- and copolymers of vinyl halides, homo- and copolymers of vinyl acetates, homo- and copolymers of acrylonitriles, homo- and copolymers of urethanes, homo- and copolymers of vinylamides, and copolymers formed from two or more of the monomer units forming the aforementioned polymers.

18. The process according to claim 2, wherein the at least one essentially water-insoluble polymer is used in the colloidal dispersion in uncrosslinked, partly crosslinked or fully crosslinked form.

19. The process according to claim 3, wherein the at least one essentially water-insoluble polymer is used in the colloidal dispersion in uncrosslinked, partly crosslinked or fully crosslinked form.

20. The process according to claim 4, wherein the at least one essentially water-insoluble polymer is used in the colloidal dispersion in uncrosslinked, partly crosslinked or fully crosslinked form.
